(19) United States
(12) Patent Application Publication
(10) Pub. No.: US 2018/0120099 A1
(43) Pub. Date: May 3, 2018

(54) Compact Laser Alignment Device and Method for Alignment

(71) Applicants: Aaron Apple, San Francisco, CA (US); Christopher Andrew Tacklind, Menlo Park, CA (US)

(72) Inventors: Aaron Apple, San Francisco, CA (US); Christopher Andrew Tacklind, Menlo Park, CA (US)

(21) Appl. No.: 15/330,706

(22) Filed: Oct. 29, 2016

(51) Int. Cl. G01B 11/27; B66F 13/00

(52) U.S. Cl. CPC G01B 11/27; B66F 13/00

(57) ABSTRACT

A simple compact laser alignment tool used to align vehicle lifts, vehicle jacks, airplane engine lifts and the like. It projects an alignment image such as an “X” onto the surface to be lifted prior to lifting. It may be mounted in the lift or readily removed for use on a sequence of lift points.

This application clams the filing date of the provisional application of the same title and inventors.

This invention was not made with government support.

### BACKGROUND OF THE INVENTION

In the servicing of automobiles, trucks, service vehicles, airplanes and the like, equipment such as lifts are in common use. Proper alignment of a lift is crucial to the safety of the technician and the craft being lifted and can dramatically affect the time required to perform the service. This is often done in cramped corners with the technician in inconvenient positions. Much time is wasted during the process. This can lead to physical injuries and mistakes and damage to the craft in addition to the lost value of the technician's time. The lift itself and/or various parts of the lift (including the lift arms) must be correctly located prior to engagement. Without a precise alignment means, repeated positioning is required during the engagement process. This is time consuming and potentially dangerous. The invention at hand addresses these issues in a compact and convenient means.

### SUMMARY OF THE INVENTION

Inexpensive laser tools are now quite common. They are routinely used in construction and industrial settings for establishing level, plumb and square relationships. They are often self-leveling or provide a means for leveling. In some specialized applications, they can be used to align structures such as pipes.

Although luggable, existing devices are still bulky. In particular, they are tall and not suited for use in confined spaces. Of particular interest are common alignment tasks such as placement of jacks and supports prior to engagement.

The shape of the light beam, which may be a laser, LED or other similar light source, has particular utility not only in establishing an axis, but also off-axis reference and range information.

Additional benefits will be clear from the detailed description of the invention.

### BRIEF DESCRIPTION OF THE DRAWINGS

FIG. 1 shows an oblique view of a preferred embodiment of the invention.

FIG. 2 shows an exploded oblique view of a preferred embodiment of the invention.

FIG. 3 shows a laser alignment tool of the prior art strapped to a jack stand under an airplane wing.

FIG. 4 shows the invention projecting a laser “X” across the underside of a wing and up into a recess.

FIG. 5 shows the invention on a rolling car jack projecting a line onto the side of a car.

FIG. 6 shows a car between a lift. The lift pads are fitted with the invention projecting onto the vehicle.

FIG. 7 shows the invention captive in a rubber lift pad with laser X projecting from an opening.

FIG. 8 shows an embodiment including a steel protective cover.

FIG. 9 shows the interior of the invention and the optical path of the beam.

FIG. 10 shows an optical element with multiple functions.

### DETAILED DESCRIPTION OF THE INVENTION

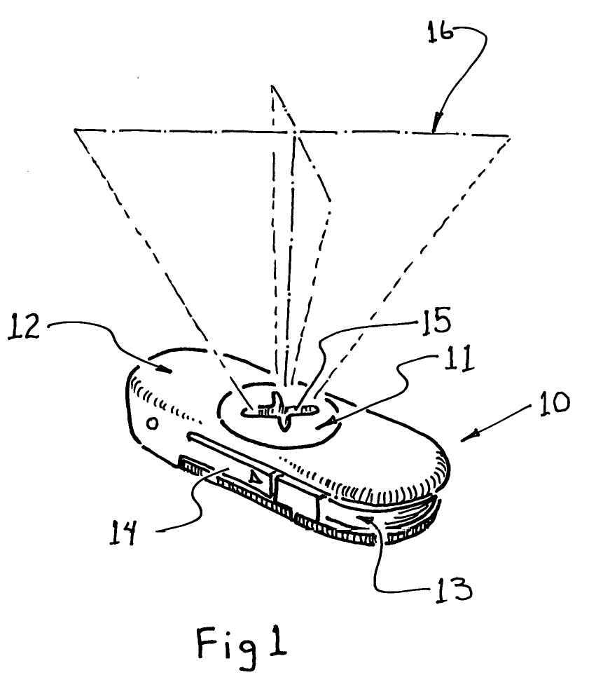

FIG. 1 shows an oblique view of a preferred embodiment 10 of the invention. In this embodiment the device is a complete self-contained compact device. No external connections or wires are needed. This makes the invention compatible with all existing jacks and lifts. A central button 11 is provided in a plastic housing 12. An aperture 15 is provided in the button allowing projection of a laser beam 16 in a cross form. The button presents itself substantially in the direction of projection. So in any use case, the button is readily accessible. In this preferred embodiment a recess on one end is provided for a coin cell battery 13. Flexible sides 14 may be provided to help extract the battery. The battery may be rechargeable or a long-life recyclable type.

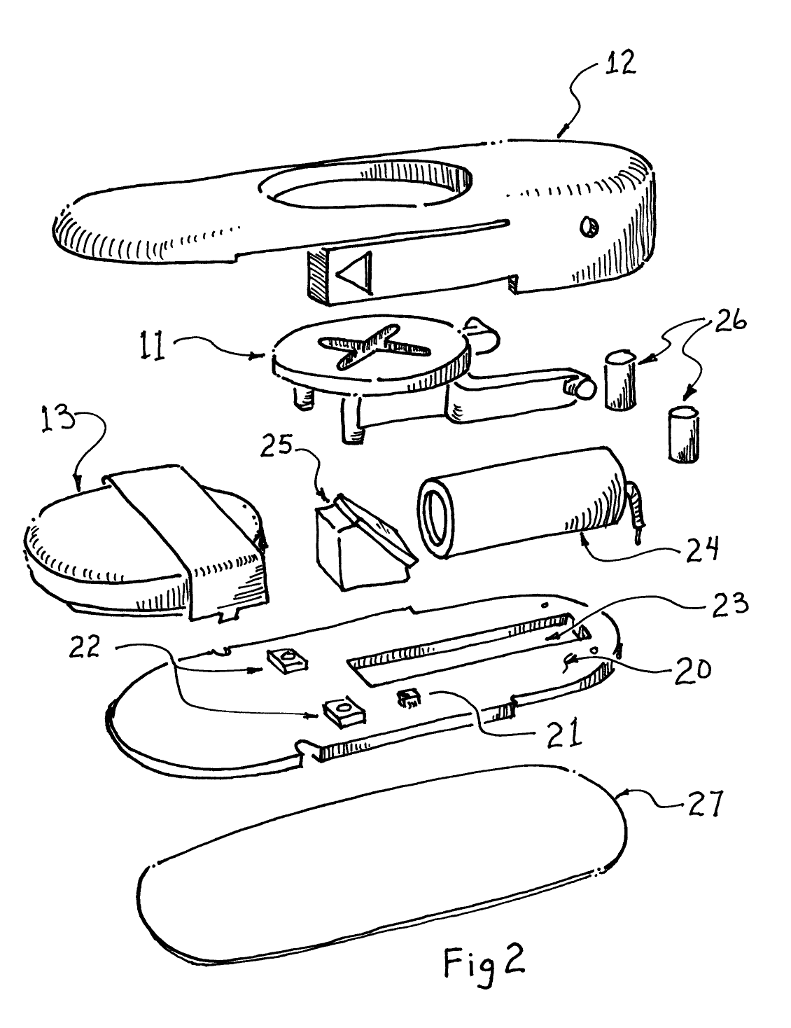

FIG. 2 shows an exploded view of the assembly. In addition to the previously described components are a circuit board 20 containing a microprocessor 21 and tactile switches 22. A notch in the board 23 positions a laser module 24. Affixed to the laser module and central to the device is an optical component 25 that generates a cross line and includes a right angle mirror. Magnets 26 may be provided for attachment to ferrous surfaces. The bottom may be capped with a separate plastic part, or as shown in this case, by a polycarbonate sticker 27. The interior of the device may be “potted” with epoxy (not shown) or treated with a conformal coat to prevent water or dust damage.

To ensure the compact design, a small battery is used. A basic trick to ensure long life is to include an auto-off function. This is readily accomplished with a resistor and capacitor establishing a time reference. Surprisingly, the physical size of the required capacitor is large. This motivates the use of a tiny microprocessor. As will be clear to one skilled in the art, the microcontroller is programmed in assembly code to achieve any desired behavior. While not in use, it sleeps in a very low power state. Once per second, it wakes up and checks the state of the tactile buttons. If not pressed, the processor goes back to sleep. A coin cell battery will last years in this mode. If the button is pressed, the unit turns on and for a predefined period of time, in this case, 30 seconds. In a preferred embodiment, if the button is pressed additional times, the device will stay on for an additional 30 second interval. If the button is pressed and held for two seconds the unit shuts off. When a new battery is installed, the processor recognizes this special case and turns on the laser briefly indicating proper operation.

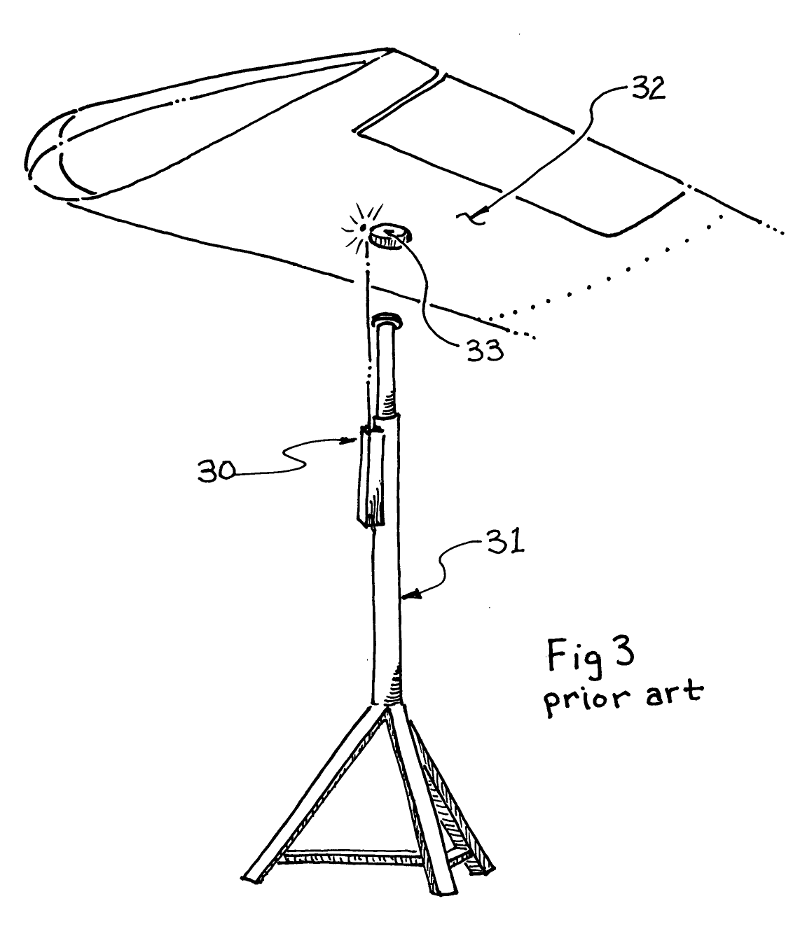

FIG. 3 shows a laser device 30 of the prior art strapped to the side of a telescoping jack stand 31 used for holding an airplane wing 32. The jack is considerably shorter than the height of the airplane lifting point 33. The jack must be placed roughly in the correct position, jacked up partially avoiding any collisions. Then the alignment is checked and the jack is adjusted laterally. This procedure is repeated until the jack is close enough for engagement.

This is tedious and difficult if the jack is heavy. The laser device 30 is helpful, but not sufficient for the task. The first problem is that the beam is off axis from the center of the jack and jacking point. The operator is required to estimate this offset. Using a pair or multiplicity of beams would be helpful in reducing this estimation error. Indeed, a centrally located laser beam may be helpful to establish the central axis.

This approach is disclosed in the invention of Brake U.S. Pat. No. 8,690,125. It is seriously deficient in that the beams produce a spot only in areas with sufficient reflectivity and opportune position. For a jacking point inside a wing, for example, the beams have no suitable surface. Indeed, the central jacking point may be a grease covered socket thwarting the visibility of the spot.

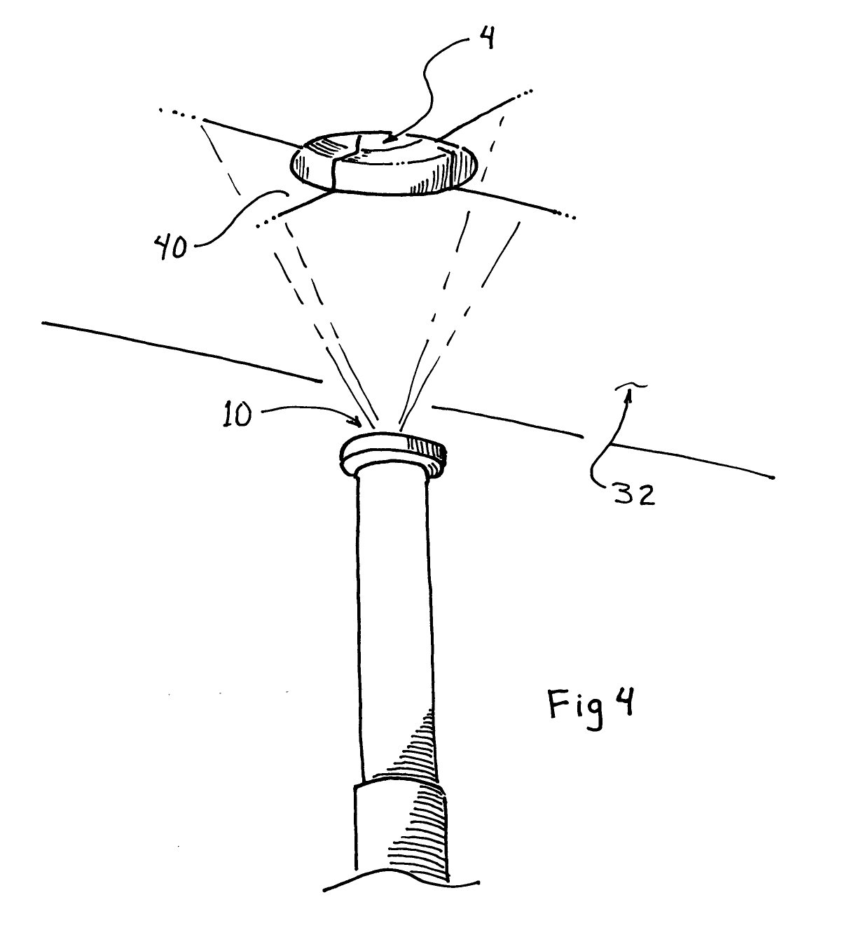

FIG. 4 shows the invention 10 perched on top of a jack stand projecting a laser “X” onto the underside of a wing and onto the jack point in a recess 41. From this vantage point, a multiplicity of laser beams would not be visible as they would project somewhere up into the recess. However, the laser lines, produced by a single laser module, are clearly visible on the wing clearly indicating the central axis established by the crossing of the beams. The projection of the line across the center of the jacking point is clearly visible from orthogonal positions, verifying the alignment.

The additional utility should be noted that the invention sits conveniently on the top of the jack stand. No straps are needed. The perpendicular relationship is substantially guaranteed by the squareness of the jack stand to the axis of motion of the jack. Magnets 26 in the invention will often be useful for securing the device against accidental bumps. After positioning of the jack, the invention is readily removed placed in a pocket and ready for use on the next jack point.

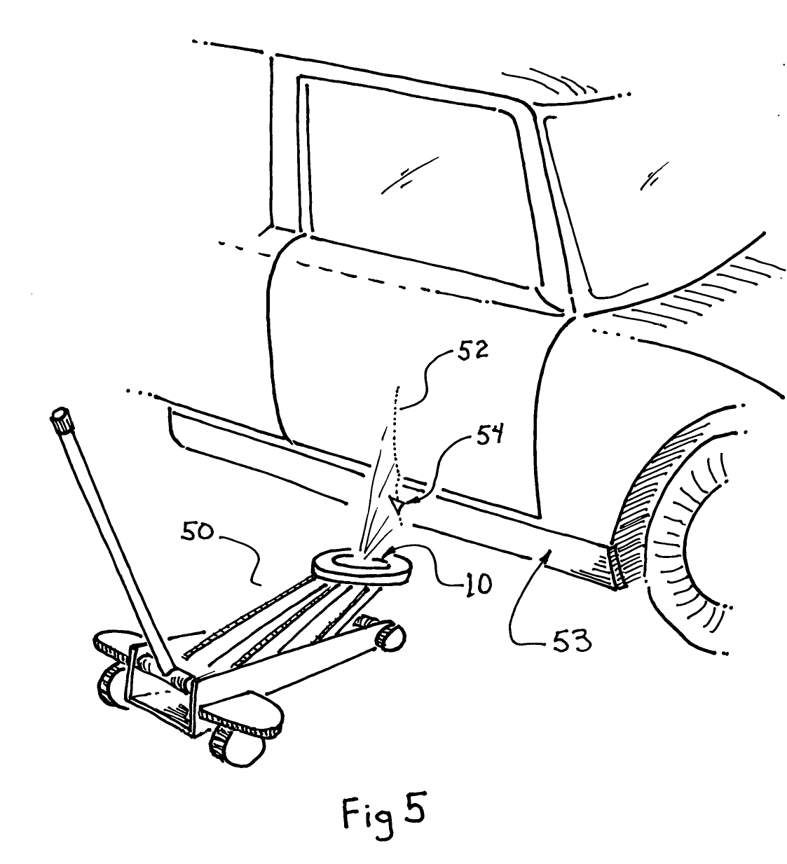

Another use case is placing the device on the lift pad 50 of an automotive floor jack 51, as shown in FIG. 5. The cross beam is aligned substantially with the preferred rolling axis of the jack. As the jack approaches the side of the vehicle, a laser line is clearly visible on the side panel or skirt 53 of the vehicle. Occasionally a vehicle will have jack point indicators 54 on the skirt. This allows the jack to be properly aligned to the jack point while rolling into place. The cross line can then be use to visualize the insertion depth of the jack.

Another user may prefer to position the invention square to the vehicle. Then a pair of lines are projected on the vehicle as the rolling jack approaches the car. The imaginary line directly between the laser lines is the center of the jack, so a reasonable indication of the jack center is presented. The gap between the lines decreases as the jack approaches, increasing the accuracy of the center estimate. In some cases, the beams can be seen on the skirt when the jack is in the desired position, adding confidence of the placement.

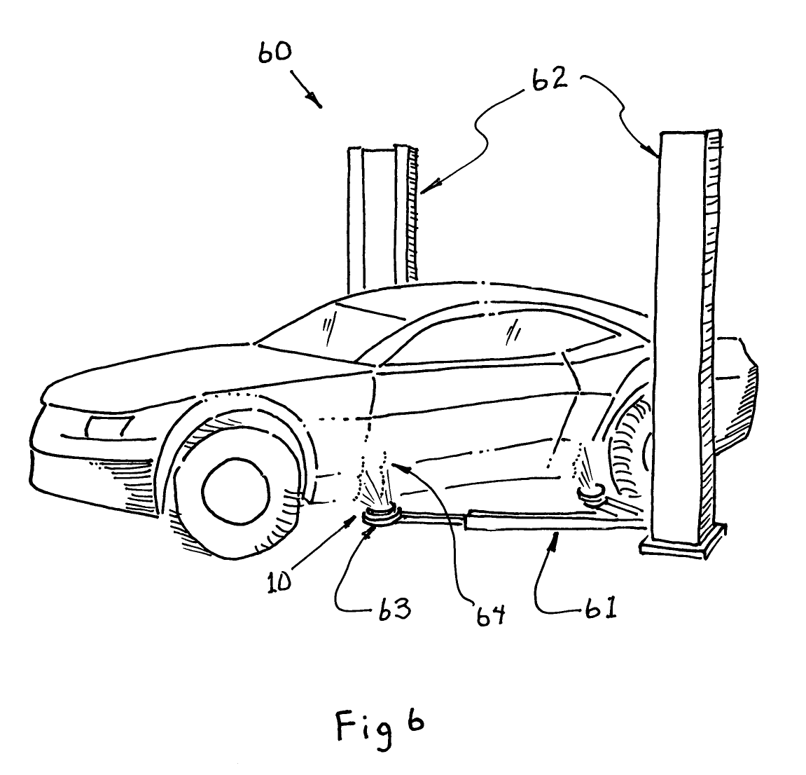

The use case is similar in the case of a car lift 60 as shown in FIG. 6. Car lifts come in a variety of styles. Some lift the car by the wheels but more commonly they lift by touching four places on the under carriage of the vehicle being serviced. This is readily achieved by rotating and telescoping arms 61 which protrude from the posts 62. In this case, the laser X projecting form the invention placed on each pad 63 helps align the axis of the pad directly with each jack point. As the jack pad is slid into position, the laser light projects 64 on the side of the vehicle. After each pad is aligned the device is easily moved to the next pad. In some cases it will be desirable to use one device per pad. In the above use cases, the device is portable and removable from a common jacking device.

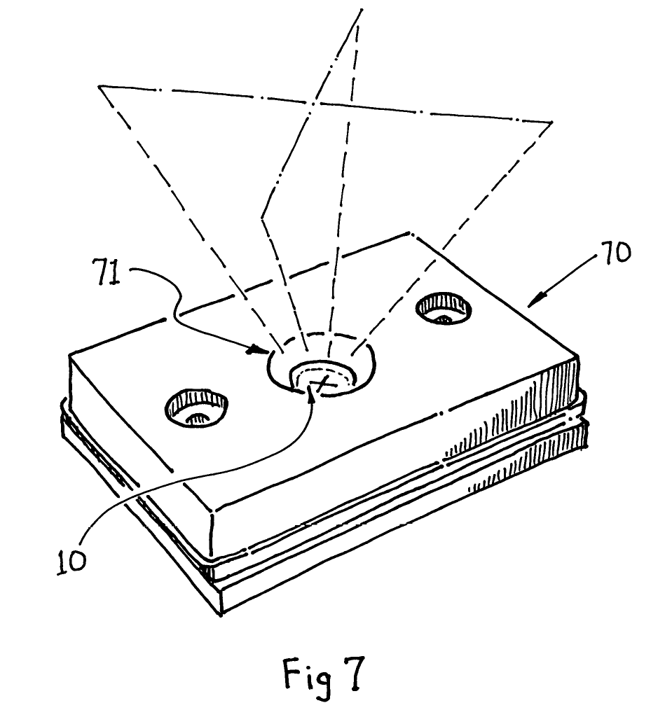

In many cases, accommodations may be made for the laser device. In particular, the rubber pads 70 used on car lifts may be provided with a recess 71 large enough for the device. In a preferred embodiment the recess is from below, trapping the device in place, as shown in FIG. 7. A tapered opening is provided to access the power button and not obstruct the laser X. Since the device is substantially thinner than the rubber pad, the device is well shielded from damage.

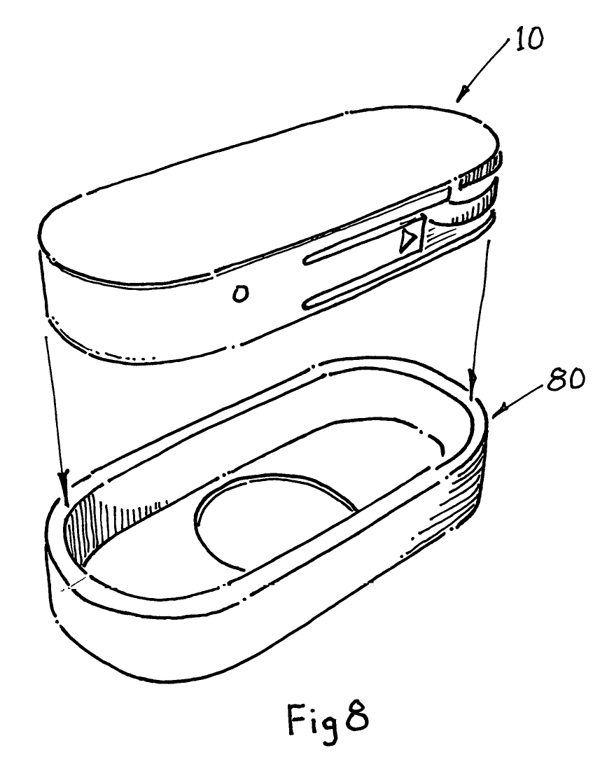

In most cases, the plastic and epoxy construction makes the device quite rugged and uncrushable. In some cases, it may be desired to offer extra protection to the device by adding a shield 80 as shown in FIG. 8. The shield may be constructed out of steel (stainless/non-stainless), aluminum, or other materials able to withstand the pressure created during usage of the device. Magnets inside the device may hold the shield securely in place while handling and while placing in a recess provided in a rubber pad, should the material be constructed out of a ferrous material.

In these more permanent installations, a preferred embodiment may include a tiny power cord running to a central power source. This power source could be a “wall wart” or a larger battery pack. In this preferred embodiment, a single power switch may be provided for a gang of laser modules.

The light emanating from the device in a preferred embodiment is provided by a laser diode module. The optical power and range required for the device is so modest, the light may alternately be supplied by an LED. In general any desired pattern may be selected for the output. In a preferred embodiment for some applications the light projected may be a simple beam or a cone.

In the case of a conical projection of light, a circle is produced on a nearby surface that is substantially perpendicular to the axis of the laser cone. In the case where the cone angle is 90 degrees the diameter of the circle is substantially twice the distance from the device to the surface. In a preferred embodiment, the cone angle is substantially 53.13 degrees. In this case the diameter of the projected circle is substantially the distance to the module. This aids in guiding the lift to its engagement position.

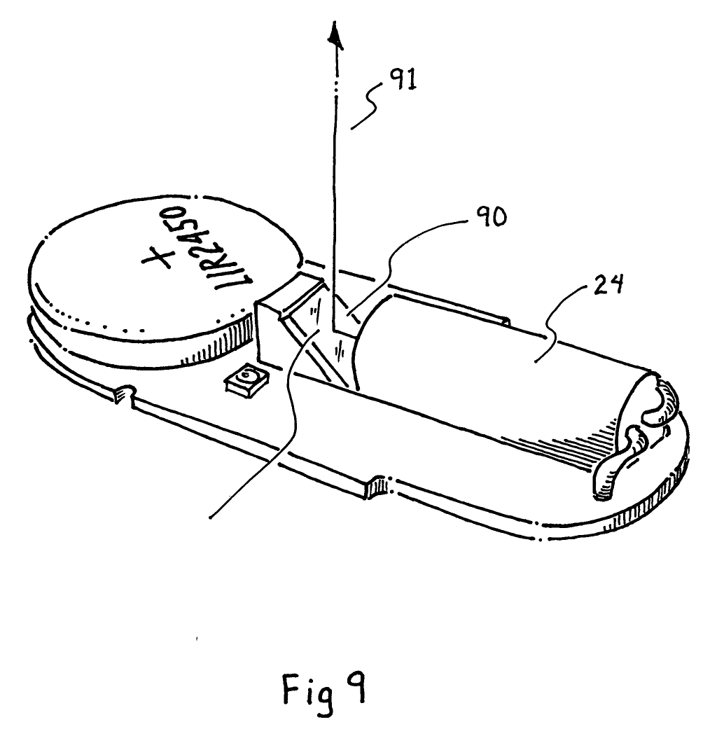

In the preferred embodiment shown in FIG. 9 the laser module output axis 90 is perpendicular to the device output axis 91. In this case, a right angle bend is needed in the optical path. This is readily achieved with an optical device 92, which may be a mirror, a pentaprism, or a corner prism or other element that produces a substantially ninety degree bend in the light beam.

Optics to make any desired pattern are readily fabricated in glass plastics or films. Glass is often used in high quality optics but tends to be expensive. Films are often used to make holographic projections. Plastic optics are well suited for a preferred embodiment. The optical quality is adequate for short range projection. Thermal stability is also not critical in these applications. An additional advantage of plastic optics the ability to mold several functions into one compact element.

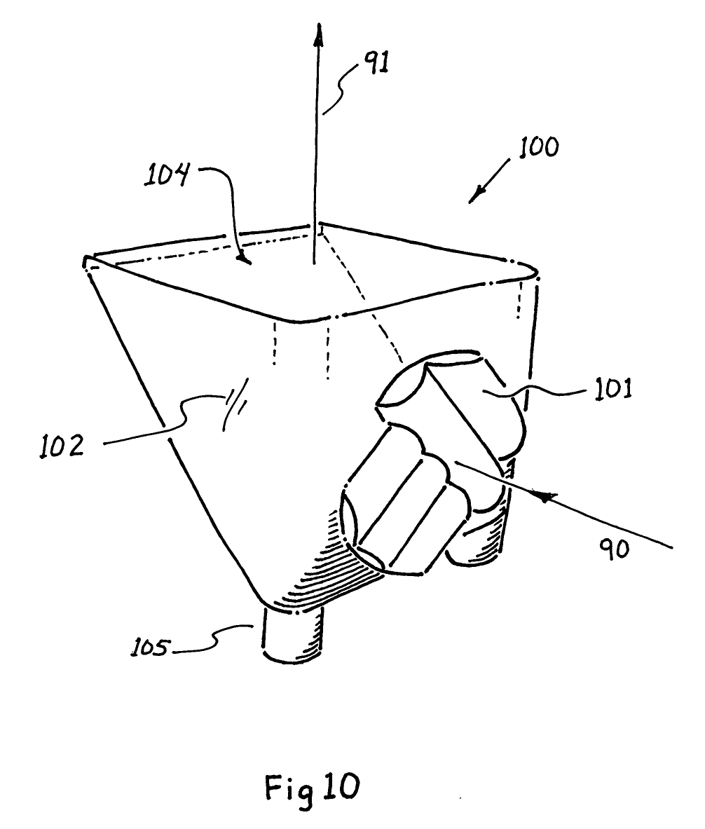

In a preferred embodiment shown in FIG. 10 a single plastic element 100 includes a lenticular array 101 for producing a cross pattern, a silvered reflective surface 102 at substantially forty-five degrees to the input axis 90, a flat output surface 104, and mounting features 105.

What we claim is:

1. A jack alignment tool comprising:
a compact housing containing
a light source
a pattern generator and a
power source
which projects the light pattern from the housing.

2. A device as in claim 1 where the power source is a battery.

3. A device as in claim 1 where the power source is an external power supply.

4. A device as in claim 1 where the light source is a laser.

5. A device as in claim 4 where the laser light is formed into a cross form by an optical element.

6. A device as in claim 5 where the cross form is reflected substantially 90 degrees by a mirror to emerge from the top face of the device.

7. A device as in claim 4 where the laser light is formed into a cross and reflected substantially 90 degrees by a monolithic cross form generator and prism with a reflective surface.

8. A device as in claim 1 with the addition of an electrical button.

9. A device as in claim 8 where the button is an on-off switch.

10. A device as in claim 8 where the button is connected to a microprocessor.

11. A device as in claim 10 where in response to a button press the microprocessor turns on the light source for a time interval between 1 second and many minutes after which the device goes into a power save mode.

12. A device as in claim 11 where if the light is on, subsequent presses increases the number of time intervals.

13. A device as in claim 10 wherein if the light source is on and the button is pressed and held the device turns off and goes into a power save mode.

14. A device as in claim 1 with the addition of a fastening means for attaching the device to a surface.

15. A device as in claim 14 where the fastening means is magnets.

16. A device as in claim 14 where the fastening means is a pocket in a lifting pad.

17. A device as in claim 16 where the pocket in the lifting pad captures the device.

18. A device as in claim 1 with the addition of a metal jacket protecting it from crushing.

19. A method of aligning a lift device consisting of the steps of:
activating the compact patterned light device contained on the lifting device, observing the projected light pattern onto the receiving port or surface of the item to be lifted, positioning the lifting device to align the image to the lifting surface or port, advancing the jack so aligned to the lifting surface or port.

20. A method as in claim 19 with the additional steps of:
placing the compact patterned light device onto the lifting pad, and removing said device prior to engagement of the pad to the lifting surface or port.
